(19) United States
(12) Patent Application Publication
(10) Pub. No.: US 2012/0053964 A1
(43) Pub. Date: Mar. 1, 2012

(54) SYSTEMS AND METHODS FOR ONLINE INSURANCE FINANCIAL PLANNING

(76) Inventors: Sarah A. Williams, Springfield, MA (US); Frederick J. Jones, JR., Glastonbury, CT (US); Bruce J. Conklin, Southwick, MA (US)

(21) Appl. No.: 12/871,491

(22) Filed: Aug. 30, 2010

(51) Int. Cl. G06Q 40/00; G06Q 10/00

(52) U.S. Cl. 705/4; 705/35

(57) ABSTRACT

A computer system receives and stores information relating to actual past financial results, expected future trends in financial results, and anticipated effects of initiatives intended to change the expected trends. The system processes the information and generates first and second forecast data. The first forecast data indicates forecast financial results without considering the effects of the initiative. The second forecast data indicates forecast financial results that reflect expected results of the initiatives. The first and second forecast data are stored and subsequently displayed to users.

### FIELD

The present invention relates to computerized financial planning systems.

### BACKGROUND

Financial planning is a key function in many businesses and generally increases in importance with the size of a business enterprise. In many large companies, computerized spreadsheet programs are a basic tool used in financial planning. However, spreadsheet programs tend to have significant drawbacks when used in enterprise financial planning. Often it is difficult to share and update individual spreadsheet documents used for planning purposes. A particular issue involves “stove-piping” in that it is difficult to gather information or share information across departments and areas of functional responsibility.

Another disadvantage of conventional financial planning systems relates to consistency in defining terms and making assumptions. It is not uncommon for planning processes to be fragmented and to have varying terms and definitions across departments of a single business entity. This fragmentation may make it necessary to engage in time- and labor-intensive translation of planning documents from various individual systems into a common system in order to produce aggregate plans for an entire organization.

Further, with spreadsheet-based planning systems, or even with more centralized systems, there is often a lack of connectivity between the planning system and other finance-related computer systems, such as systems used for periodic reporting or strategic planning. Consequently, it may be necessary to manually enter data from other systems into the financial planning system.

### SUMMARY

An apparatus, method, computer system and computer-readable data storage medium are disclosed which include a financial results input module for inputting financial results data, and a financial results storage module for receiving and storing the financial results data. The apparatus, method, computer system and computer-readable data storage medium may also include a trend information input module for inputting information that is indicative of expected trends in financial results, and an initiative information input module for inputting information that is indicative of expected results of at least one initiative intended to change the expected trends.

Still further, the apparatus, method, computer system and computer-readable data storage medium may include a forecasting module for receiving the financial results data, the information that is indicative of expected trends in financial results and the information that is indicative of expected results of the initiative. The financial results storage module may be coupled to the financial results input module, and the forecasting module may be coupled to the financial results storage module, to the trend information input module and to the initiative information input module.

The forecasting module may include a processor that is programmed to process the financial results data, the information that is indicative of expected trends in financial results and the information that is indicative of expected results of the initiative. The processor may also be programmed to generate forecast data which includes first forecast data that is indicative of forecast financial results that do not take the initiative into consideration, and second forecast data that reflects expected results of the initiative.

The apparatus, method, computer system and computer-readable data storage medium may also include a forecast data storage module for storing the first and second forecast data, and a display module for displaying the first and second forecast data. The forecast data storage module and the display module may be coupled to the forecasting module.

With these methods and systems, financial planning for a large organization may be performed in an efficient manner, and the likely effects of proposed business decisions can be estimated with an improved degree of confidence.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 schematically illustrates a business environment in which the present invention may be applied.

FIG. 2 is a block diagram that illustrates a computerized financial planning system provided in accordance with aspects of the present invention.

FIG. 3 is an alternative block diagram illustration of a computer system which includes the system of FIG. 2.

FIG. 4 is block diagram that illustrates a server computer that is a component of the computer system of FIGS. 2 and 3.

FIG. 5 is a block diagram that illustrates a typical computer used by an end user of the system of FIGS. 2 and 3.

FIGS. 6 and 7 are diagrams that represent data flows that occur in the system of FIGS. 2 and 3.

FIGS. 8 and 9 are example screen displays that may be provided to a user in the system of FIGS. 2 and 3.

FIGS. 10 and 11 are simplified examples of formats for reports that may be provided in the system of FIGS. 2 and 3.

FIG. 12 is an example screen display that may be provided to a user in the system of FIGS. 2 and 3.

FIG. 13 is flow chart that represents a process performed in the system of FIGS. 2 and 3.

### DETAILED DESCRIPTION

In general, and for the purposes of introducing concepts of embodiments of the present invention, a web-based enterprise-wide financial planning system is integrated with computerized financial reporting systems. The financial planning system may be implemented with a database tool for which rules are written to define data flows among data cubes. Forecasts are generated using anticipated trends in business metrics. The forecasts may also reflect anticipated effects of planned business initiatives that are intended to alter the expected trends in metrics. Financial outlook reports generated by the planning system may be made available via a company intranet with web hosting. The reports may be displayed to end users in the form of tables and/or dashboard displays.

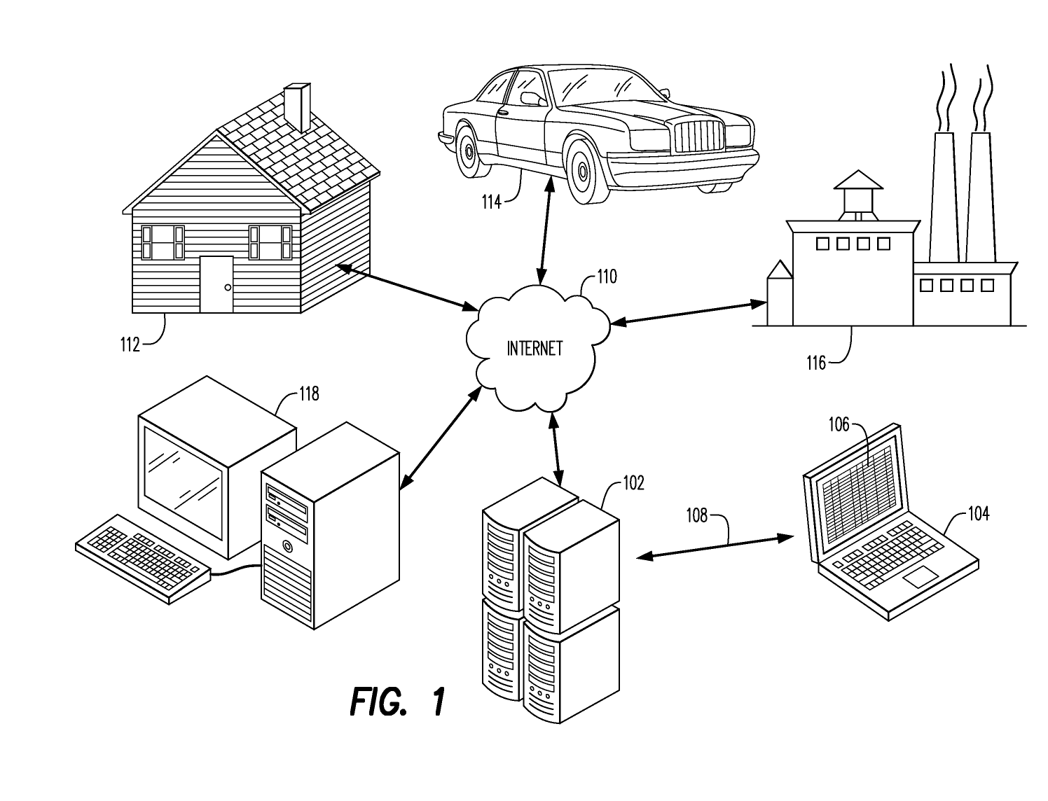

FIG. 1 schematically illustrates a business environment in which the present invention may be applied.

In example embodiments described herein, the present invention is applied to financial planning functions for an insurance company. However, principles of the present invention may alternatively be applied in other types of financial services companies, for other types of for-profit companies, as well as governmental or not-for-profit organizations.

FIG. 1 schematically shows aspects of an insurance business. As is customary, the insurance company in question operates one or more central computers, including server computer 102 shown in FIG. 1. Other computers deployed in the insurance company may include personal/notebook computers assigned to individual employees, including the computer indicated by reference numeral 104. One function that may be performed by the computer 104 is displaying report data 106 that has been downloaded to the computer 104 from the server computer 102 via a communication path 108.

The server computer 102 may also exchange information with other parties, including for example holders of insurance policies issued by the insurance company. This exchange of information may occur via private and/or public data communication networks, including the Internet (reference numeral 110). Such policy holders may include owners of residential properties 112, who are covered under homeowner's insurance policies; owners of motor vehicles 114 who are covered by motor vehicle liability and/or property damage policies; and large commercial/industrial enterprises, such as the corporate owner of a factory 116.

Still further, the insurance company may have contractual relationships with numerous independent insurance agencies which place and provide services for policies written by the insurance company. Thus the server computer 102 may engage in data communication with computers 118 operated by the company's agents.

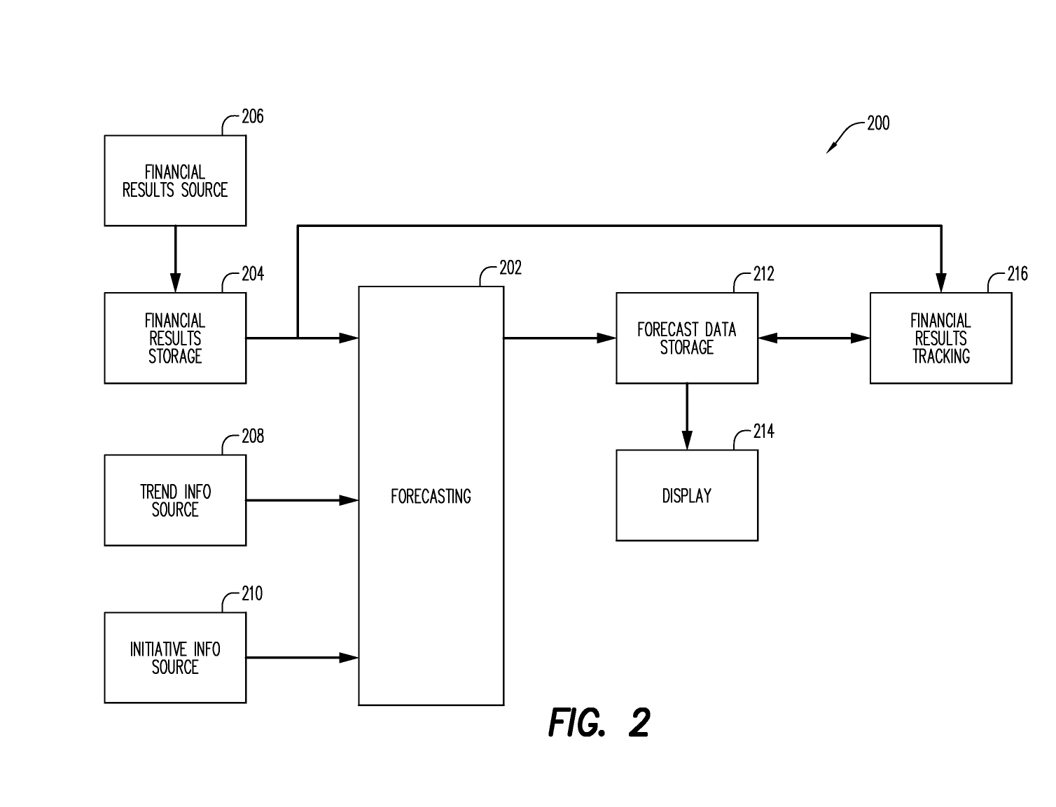

FIG. 2 is a functional block diagram that represents aspects of a financial outlook and planning system, generally indicated at 200. FIG. 2 depicts certain particularly pertinent aspects of the financial outlook and planning system 200, but in practical embodiments thereof the actual data flows may be considerably more complex than FIG. 2 may alone suggest. For example, data generated by the financial outlook and planning system 200 may include a net income forecast or outlook. The resulting bottom line outlook may, in turn be calculated based on outlooks for both revenues and expenses. Both of these data components, in turn, may be derived from two or more contributing data components. For example, the outlook for revenue may be generated based on separate constituent outlooks for both renewal revenues (e.g., premiums from renewals of insurance policies) and premiums derived from “new business” (issuance of insurance policies that were not previously in force). Expected cession and/or assumption of liabilities under reinsurance treaties may also come into play in the forecasting of revenues.

The expense or loss factors in the net income forecast may also be complex. Expense/loss components may include direct losses resulting from claims under policies in force, allocated loss adjustment expense, unallocated loss adjustment expense, and other administrative and/or overhead expenses. Each of these expense/loss components may have been forecast on a separate basis, and then may be combined into an aggregated expense/loss outlook.

For one or more of the revenue or expense forecast components, the figure used in generating the bottom line outlook may reflect anticipated trends in the components and/or expected results of one or more business initiatives proposed or planned to improve the anticipated trends. (Alternatively, in some cases, initiatives expected to have a favorable impact on some factor or factors may also be expected to have a smaller unfavorable impact on one or more other factors.) With respect to loss costs for insurance policies in force, the trends may include trends in the frequency of claims and trends in the severity of claims (amount of loss per claim). Those who are skilled in the art will recognize that the separate frequency and severity trends may together produce a combined resulting trend in loss costs.

Other elements of complexity in the forecasting process may arise from aggregation of forecast results for two or more lines of business and/or two or more market segments. As is familiar to those who are knowledgeable about information management systems for insurance companies, lines of business may include personal/consumer-oriented and commercial insurance operations. Within a commercial insurance business, typical market segments may include small businesses, middle market business and/or insurance for large organizations.

Still another form of complexity in the forecasting process may relate to the periods for which forecasts are generated. For example, future forecast periods may include a number of future months, a sequence of future calendar quarters and/or one or more future calendar and/or fiscal years.

For the most part, the drawings appended hereto are relatively abstract and/or simplified, in that much of the above-noted complexity likely to be present in practical embodiments of the invention may not be reflected in the drawings. Those who are skilled in the art will appreciate how practical, relatively complex embodiments of the invention may be arrived at based on the disclosure contained herein.

Referring again to FIG. 2, a central component of the financial outlook and planning system 200 may be a forecasting module, indicated at 202 in FIG. 2. According to a practical embodiment of the invention, the forecasting module 202 may be constituted by a suitably programmed computer processor (not separately shown in FIG. 2) or group of processors. For example, the program which implements the forecasting module may be a conventional planning software package, suitably configured with rules and data flows to embody teachings and data models as disclosed herein. One suitable commercially available planning package is known as “TM1”, available from IBM Cognos.

The outlook and planning system 200 also includes a financial results storage module 204. The financial results storage module 204 may include one or more conventional data storage components (not shown) such as one or more hard disk drives. The financial results storage module 204 stores financial results data that represents actual financial performance that has been achieved in past time periods (e.g., months, calendar quarters, financial years) by the insurance company up to the present time. The financial results data may represent the types of financial information referred to above, such as net income, revenue and expenses. This information may further be constituted by the various component amounts referred to above, such as various categories of expense and revenue, financial results figures for various market segments or types of business, etc. The financial results storage module 204 is coupled to the forecasting module 202 such that the forecasting module 202 receives the financial results data from the financial results storage module 204.

The financial results storage module 204, in turn, receives the financial results data from one or more sources of financial results, indicated by block 206 in FIG. 2. The financial results source(s) 206 may be considered part of the outlook and planning system 200, although the same may also constitute parts of a conventional computerized accounting and financial reporting system (not shown in FIG. 2 apart from block 206) for the insurance company. In some embodiments, the financial results data may be fed from the financial results source(s) 206 to the financial results storage module 204 from time to time as time periods are completed and the financial results are compiled for the time periods.

The outlook and planning system 200 also includes a trend information input module 208, which is coupled to the forecasting module 202. The trend information input module 208 may, for example, include one or more computer terminals, personal computers or the like operated by insurance company employees assigned to collect and/or generate data upon which financial forecasts are to be based. Thus the trend information input module may be used to input information that indicates trends that are expected to be experienced in one or more components of anticipated revenues and/or costs/expenses. The employees in question may generate and input the trend data based on one or more sets of economic forecast data and forecasts of insurance industry trends, all of which may be obtained from external public or private sources of economic or industry information. In addition, or alternatively, the trend information may be based on observations of trends in the insurance company's own business.

Still further, the outlook and planning system 200 may include an initiative information input module 210, also coupled to the forecasting module 202. In terms of its hardware aspects, the initiative information input module may overlap with the trend information input module. That is, the initiative information input module 210 may include the above-mentioned computer terminals and/or PCs operated by the employees who generate data upon which the financial forecasts are to be based (and/or other terminals and/or PCs). The initiative information input module may be used to input information that indicates expected results of one or management initiatives planned and/or intended to change and generate improvements in the revenue and/or expense/cost trends referred to in connection with the trend information input module.

Examples of possible management initiatives will now be discussed. For example, a new marketing and/or advertising campaign may be planned to enhance an anticipated increasing trend in revenue (e.g., for a certain category of insurance policies and/or policy holders) or to reverse or reduce an anticipated declining trend in revenue. In another example, a marketing and/or advertising campaign may be aimed at changing the prevailing mix of policy holders (e.g., for “new business”) with an expected positive impact on a trend in losses and/or costs (again, e.g., for one or more categories of insurance policies).

Another example of a proposed initiative may be introduction of a new insurance product.

Other initiatives may relate to pricing (increases in some cases, and/or decreases in others) of one or more categories of insurance policies, again with expected effects on revenue and possibly also on costs.

Still other initiatives may relate to changes in underwriting policies, with an expected improvement in trends as to frequency and/or severity of claims for certain categories of insurance policies to be written. The underwriting policy initiatives may relate to acceptance of applications for new policies, and/or renewals of existing policies.

Other management initiatives may relate to changes in claim handling procedures, with expected effects on expense items such as severity of claims and/or claim handling expenses. Such initiatives, relative to claim handling or other aspects of the insurance company's operations, may for example involve investment in and deployment of new technology (e.g., new computer systems and/or new software).

Referring again to FIG. 2, the forecasting module 202 may receive and process the actual results data and the trend data (including expected effects on trends to be derived from planned or proposed initiatives) to generate forecast data based on the results data and the trend data. In some embodiments, potential initiatives may be included as inputs to the forecasting module 202 on a “what if” basis, with different iterations of (i.e., scenarios for) the planning/forecasting process based on different assumptions about what effects the proposed initiatives may have on trends, and/or with different combinations of initiatives and/or with or without one or more proposed initiatives.

The outlook and planning system 200 may also include a forecast data storage module 212. The forecast data storage module may be coupled to the forecasting module and may store sets of forecast financial data generated by the forecasting module 202. For example, the forecast data storage module may store sets of financial forecast data associated with various scenarios of one or more proposed initiatives or combinations of initiatives.

In addition, the outlook and planning system 200 may include one or more display modules 214 to which financial forecast data may be downloaded from the forecast data storage module for display to managers, planners and financial executives and other executives of the insurance company. For example, the display modules 214 may be constituted by the display components of personal computers assigned to insurance company management personnel and served as client computers from a server computer (not separately shown in FIG. 2) which includes the forecast data storage module 212.

Also, the outlook and planning system 200 may include a financial results tracking module 216. The financial results tracking module 216 may be coupled to the forecast data storage module 212 and to the financial results storage module 204. From the forecast data storage module 212, the financial results tracking module may receive a set of financial forecast data (e.g., one which reflects a set of one or more initiatives that were actually undertaken). From the financial results storage module 204, the financial results tracking module 216 may receive sets of updated actual financial results from time to time as the same are compiled. The financial results tracking module 216 may compare the actual financial results against the forecast to determine whether and to what extent the executed initiatives had the expected effect. The resulting set of comparison results may be fed from the financial results tracking module 216 to the forecast data storage module 212, from which the comparison results may be downloaded for display by the display module(s) 214. The comparison data may include variance data that indicates differences between the updated financial results data and the forecast data.

At least some of the components depicted in FIG. 2 may be physically integrated with each other. For example, one or more of the financial results source(s) 206, the trend information input module 208 and the initiative information input module 210 may be constituted by the same computer, such as a personal computer (not separately shown).

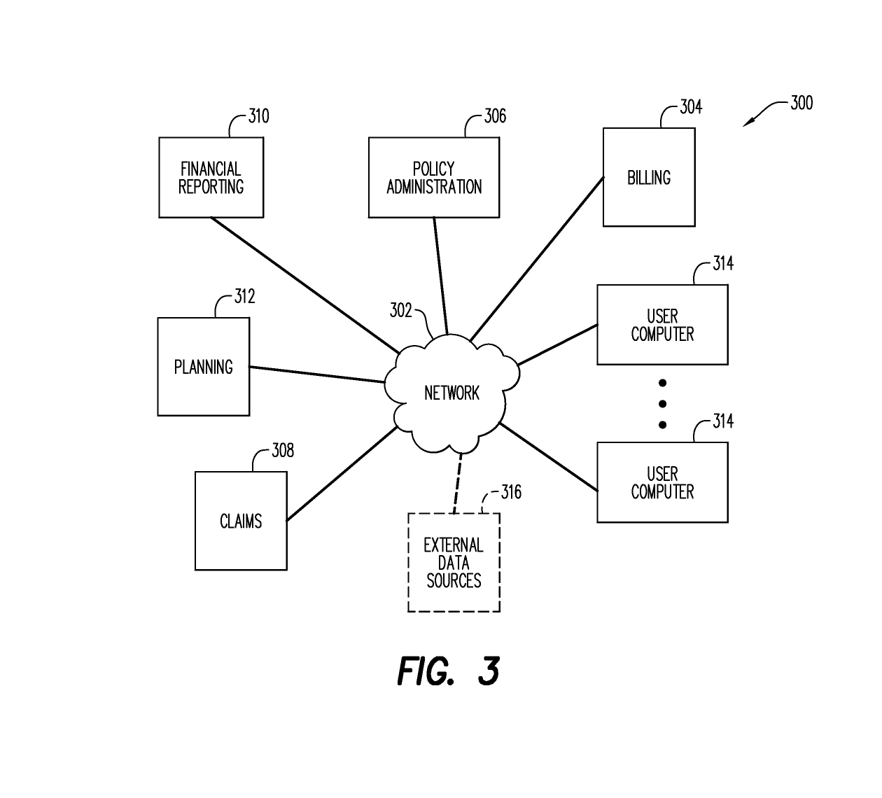

FIG. 3 is a somewhat more comprehensive depiction of data processing resources of the insurance company. That is, FIG. 3 is a block diagram of a more or less integrated computer system 300 which serves the insurance company. The computer system 300 may for example be a superset of the outlook and planning system 200 shown in FIG. 2. The computer system 300 may include a conventional data communication network 302. Further the computer system 300 may include a number of conventional server computers, such as a billing server 304, a policy administration server 306 and a claims server 308. All three of these servers may be coupled to the data communication network 302.

In addition, the computer system 300 may include a financial reporting server computer 310, which may also be conventional, and which may constitute at least a portion of the financial results source(s) 206 (FIG. 2). The financial reporting server computer 310 may also be coupled to the data communication network 302.

Further, the computer system 300 may include a planning server computer 312, which may be provided in accordance with aspects of the present invention as described herein, and which may constitute most or all of the outlook and planning system 200 depicted in FIG. 2.

Still further, the computer system 300 may include a considerable number of personal computers 314 that are assigned to employees of the insurance company. The PCs 314 (also referred to as “user computers”) are coupled to the data communication network 302 and may, among other functions, constitute the trend information input module 208, the initiative information input module 210, and the display module(s) 214, all discussed above in connection with FIG. 2. Except possibly for some aspects of the software that controls the user computers, the same may be conventional.

The computer system 300 may also include other components that are not depicted in the drawing, and may perform functions in addition to those explicitly referred to herein.

Also shown in phantom in FIG. 3 are external data sources 316, which may include Internet based data resources accessible by components of the computer system 300 via the data communication network 302. These data sources may, for example, include sources of economic and industry forecast data.

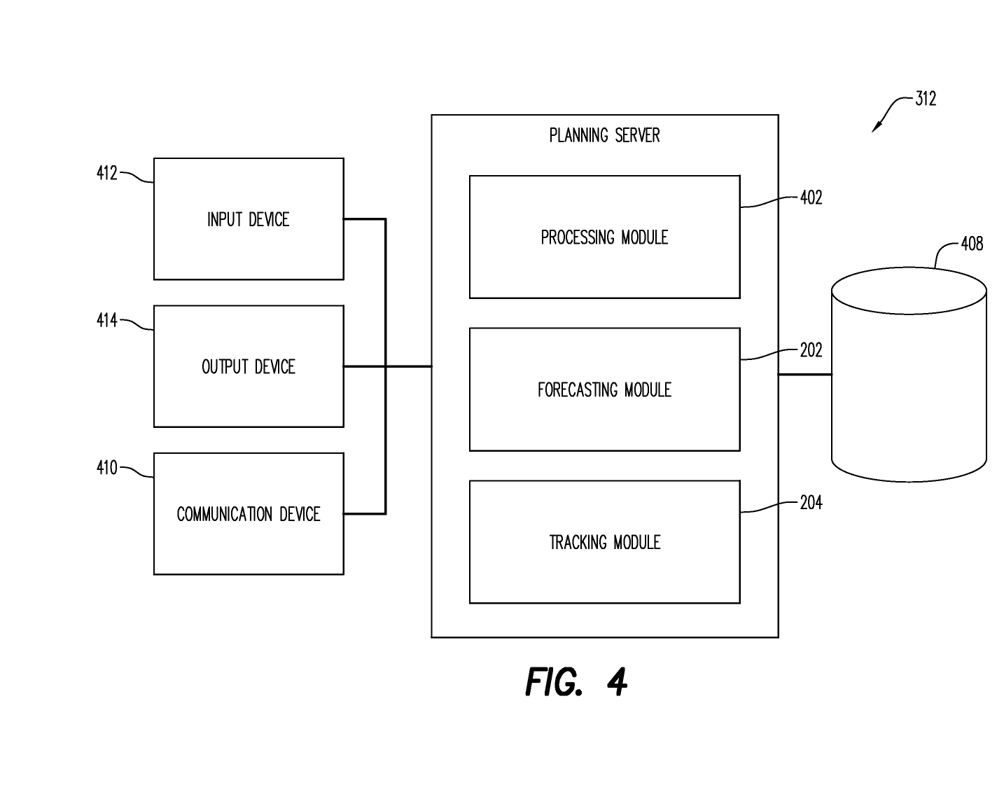

FIG. 4 is a block diagram representation of the planning server computer 312 shown in FIG. 3. The planning server computer 312 may be conventional in terms of its hardware aspects.

As depicted in FIG. 4, the planning server computer 312 includes a processing module 402, which may be constituted by one or more conventional computer processors. The planning server computer 312 further includes the above-mentioned forecasting module 202 and tracking module 216 (also referred to as the “financial results tracking module”). The modules 202 and 216 may be constituted, at least in part, by the processing module 402 in combination with suitable software program instructions. Aspects of the software program instructions for the modules 202 and 216 will be described below.

The planning server computer 312 further includes one or more storage devices, represented by item 408 in FIG. 4. The storage devices 408 are coupled for data communication with the processing module 402 and may comprise any appropriate information storage device, including combinations of magnetic storage devices (e.g., magnetic tape and hard disk drives), optical storage devices, and/or semiconductor memory devices (such as Random Access Memory (RAM) devices and Read Only Memory (ROM) devices). At least some of these devices may be considered computer-readable storage media, or may include such media. The storage devices 408 may store the above-mentioned software program instructions and/or other program instructions to control the processing module 402 such that the planning server computer 312 provides desired functionality, as described herein. Thus, the storage devices 408 store one or more programs for controlling the processing module 402. The processing module 402 performs instructions of the programs, and thereby operates in accordance with aspects of the present invention. In some embodiments, the programs may include one or more conventional operating systems. The programs may further include application programs such as a conventional data communication program and a conventional database management program. The programs stored in the storage devices 408 may also include a conventional planning software application, such as the above-mentioned IBM Cognos TM1, configured in accordance with aspects of the present invention. Aspects of the application programs will be described below. Still further, the storage devices 408 may store one or more databases relating to actual and forecast or planned financial results. The above-mentioned financial results storage module 204 (FIG. 2) and forecast data module 212 also may be at least partly constituted by the storage devices 408.

Continuing to refer to FIG. 4, the planning server computer 312 may further include one or more communication devices 410 coupled to the processing module 402. The communication devices 410 may function to facilitate communication with, for example, other devices (such as the user computers 314, and the financial reporting server 310). In addition, the planning server computer 312 may include one or more input devices 412 such as a keyboard, a keypad, a mouse or other pointing device, a microphone, knob or a switch, an infra-red (IR) port, a docking station and/or a touch screen. The input device(s) 412 may be coupled to the processing module 402. Still further the planning server computer 312 may include one or more output devices 414, such as a display (e.g., a display screen), a speaker, and/or a printer. The output devices 414 may also be coupled to the processing module 402.

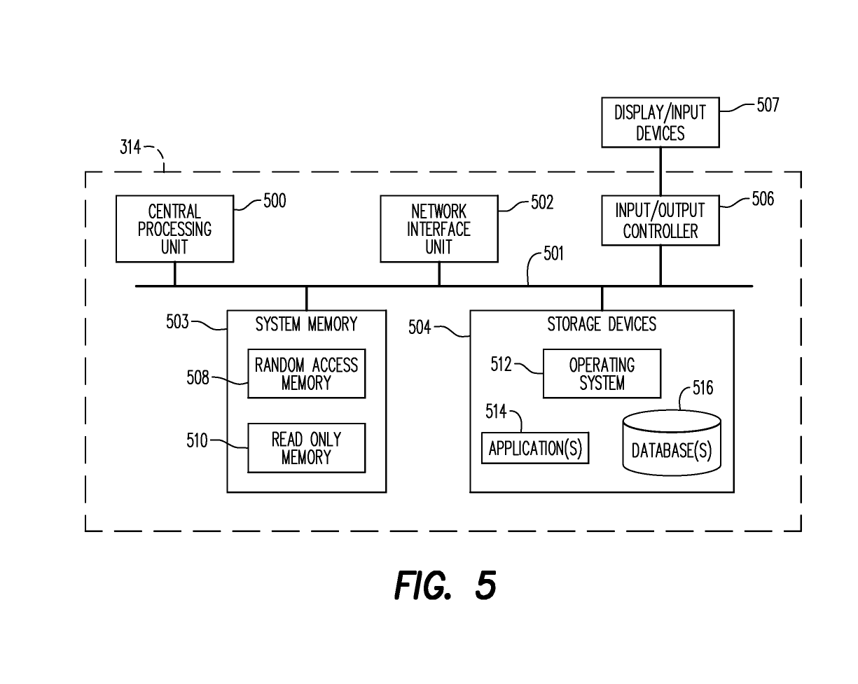

FIG. 5 is a block diagram representation of a typical one of the user computers 314 shown in FIG. 3. The user computers 314 may be conventional in terms of their hardware aspects.

As depicted in FIG. 5, the user computer 314 includes a data bus 501. The user computer 314 also includes a computer processor (CPU) 500 which is operatively coupled to the data bus 501 and which may be constituted by one or more conventional processors. The user computer 314 further includes a network interface unit 502, system memory 503, one or more storage devices 504, and an input/output controller 506, all of which are also operatively coupled to the data bus 501.

The network interface unit 502 may function to facilitate communication with, for example, other devices (such as the planning server computer 312). The input/output controller 506 may couple the user computer 314 to input and output devices (block 507) such as a keyboard, a keypad, a mouse or other pointing device, a microphone, knob or a switch, an infra-red (IR) port, a docking station, a touch screen, a display (e.g., a display screen), a speaker, and/or a printer. Thus block 507 may be taken to represent a typical one of the display module(s) 214 shown in FIG. 2.

The system memory 503 may be constituted by, for example, a suitable combination of Random Access Memory (RAM) devices 508 and Read Only Memory (ROM) devices 510.

Storage devices 504 may comprise any appropriate information storage device, including combinations of magnetic storage devices (e.g., magnetic tape and hard disk drives), optical storage devices, and/or semiconductor memory devices. At least some of these devices (and/or all or part of the system memory 503) may be considered computer-readable storage media, or may include such media.

Storage devices 504 store one or more programs (at least some of which being indicated by blocks 512, 514) for controlling CPU 500. CPU 500 performs instructions of the programs, and thereby operates in accordance with aspects of the present invention. In some embodiments, the programs may include one or more conventional operating systems, indicated by block 512 in FIG. 5. The programs may further include application programs (block 514) such as a conventional browser, a conventional data communication program and a conventional database management program. The application programs 514 may include suitable software for, e.g., generating trend information and feeding the trend information to the planning server computer 312. (Alternatively, these functions may be accomplished via functionality hosted by the planning server computer 312 and accessed by the user computer 314 via a browser program.)

There may also be stored in the storage devices 504 other software, such as device drivers, etc.

Still further, the storage devices 504 may store one or more databases (block 516) for storing and managing the data relating to operation of the user computer 314.

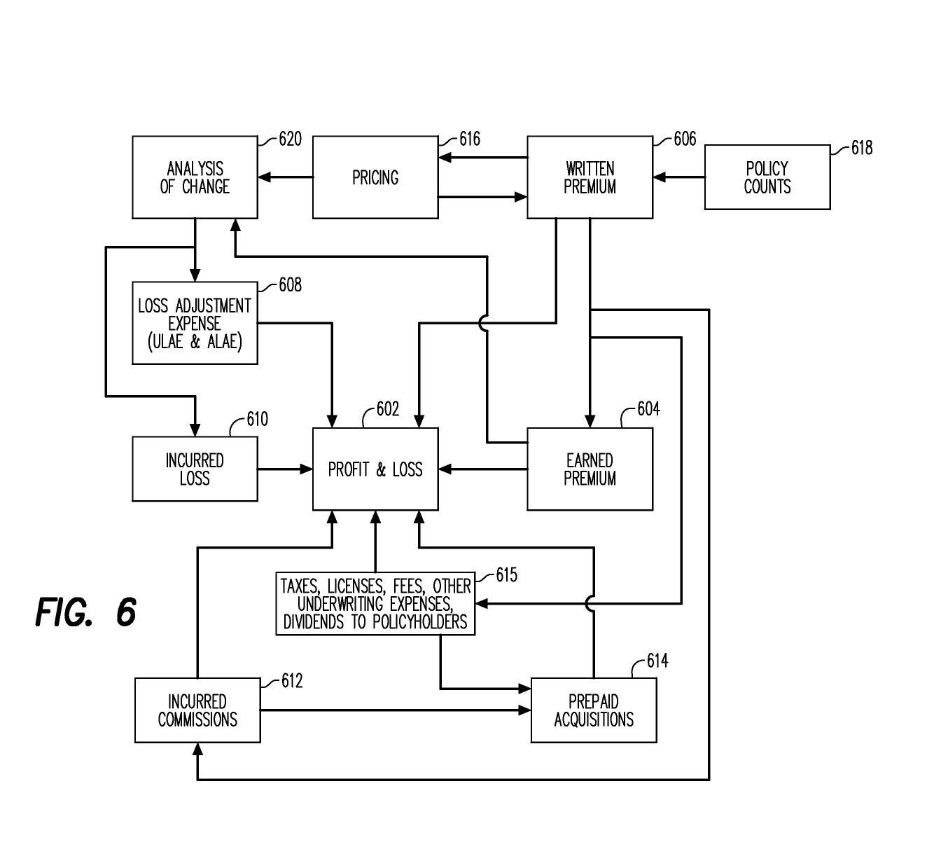

FIG. 6 is a high level diagram that illustrates example data flows that may occur in connection with operation of the planning server computer 312. For example, these data flows may indicate how the planning server computer 312 generates a net income (profit and loss) forecast from constituent data components. In FIG. 6, the P&L forecast is represented by block 602.

Each one of the blocks shown in FIG. 6 may represent what is referred to as a “data cube” or simply a “cube” in a data modeling system. It was mentioned above that FIG. 6 is a “high level” diagram, and from this it will be understood that more detailed data flows may be provided to implement additional cubes and additional relationships among cubes that make up a data model provided for forecasting purposes. The specific details of each embodiment depend on the particular accounting and/or forecasting breakdowns of revenues and/or expenses that are deemed appropriate by the entity that is performing the forecasts. An example of a data flow diagram with more detail will be described below.

Referring again to FIG. 6, the inputs to the P&L cube 602 include “earned premium” (block 604), and “written premium” (block 606). Other inputs to the P&L cube 602 include “loss adjustment expense” (block 608; representing both unallocated and allocated loss adjustment expense), and “incurred loss” (block 610). Still other inputs to the P&L cube 602 include “incurred commissions” (block 612) and “prepaid acquisitions” (block 614), as well as block 615, representing “TL&F” (i.e., taxes, licenses and fees) plus other underwriting expenses and dividends to policy holders.

FIG. 6 further indicates that “written premium” (block 606) is an input to “earned premium” (block 604), and that “pricing” (block 616) and “policy counts” (block 618) are inputs to “written premium” (block 606). “Analysis of change” (block 620) is an input to “incurred loss” (block 610) and to “loss adjustment expense” (block 608). “Earned premium” (block 604) and “pricing” (block 616) are inputs to “analysis of change” (block 620). “Written premium” (block 606) is an input to “pricing” (block 616) and also to “incurred commissions” (block 612) and “TL&F” (block 615). Inputs to “prepaid acquisitions” 614 include “TL&F” (block 615) and “incurred commissions” (block 612).

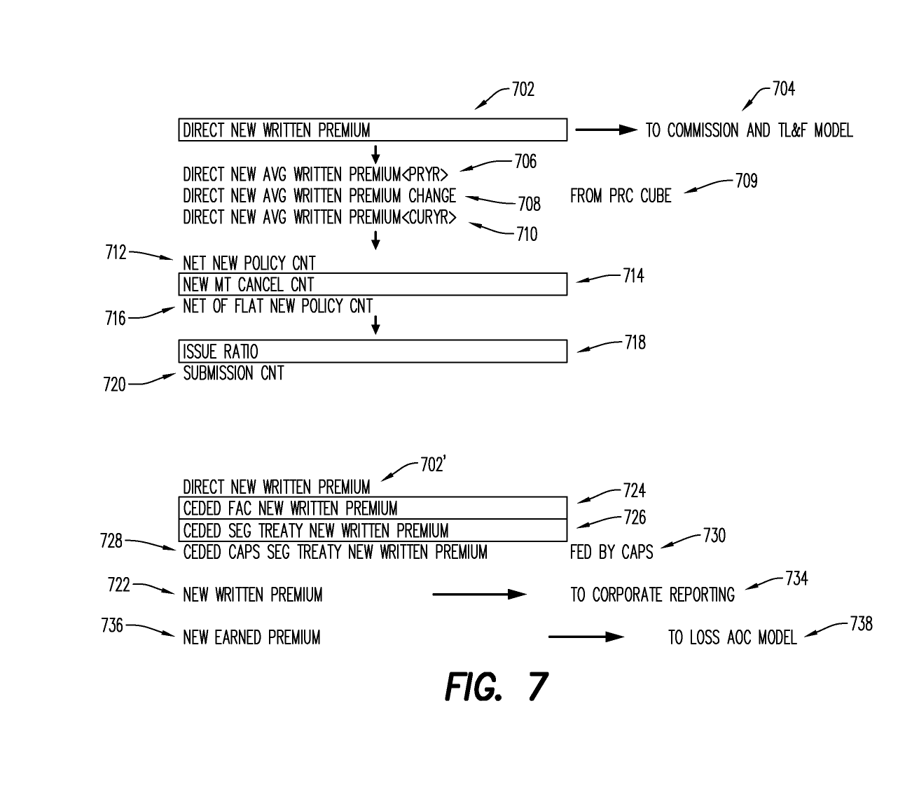

FIG. 7 is a diagram that represents data flows among certain cubes of the data model at a more detailed level. This is only a partial view of the total data flows within the model; those who are skilled in the art will understand from the examples provided in FIGS. 6 and 7 how to arrange data flows within the entire data model according to specific desired configurations of a forecasting system. In the particular example shown in FIG. 7, data flows are shown that relate to the “new business premium” cube for a “middle market” segment of the insurance company's activities.

At 702, data is input (e.g., by an employee providing input to the data model) with respect to “direct new written premium”. This data is fed to the commission and TL&F portion (item 704) of the model, and also is an input to “direct new average written premium—prior year” (item 706). At 708, “direct new average written premium change” is fed into the new business premium model from the pricing cube 709.

“Direct new average written premium—prior year” and “direct new average written premium change” are inputs to “direct new average written premium—current year” (item 710), which in turn is an input to “net new policy count” (item 712). “New mid-term cancel count” is entered at 714 by the insurance company employee, and with “net new policy count” 712 becomes an input to “net of flat new policy count” 716.

At 718, the insurance company employee enters “issue ratio” which—with “net of flat new policy count” 716—becomes an input for “submission count” (item 720).

“Direct new written premium” appears a second time in the diagram at 702′, as an input to “new written premium” (item 722). Other inputs to “new written premium” 722 are “ceded facility new written premium” (item 724) and “ceded segment treaty new written premium” (item 726), both entered by the insurance company employee. Still another input to “new written premium” 722 is “ceded CAPS segment treaty new written premium” (item 728; fed from CAPS—corporate asset protection—model 730).

“New written premium” 722 is an input to “corporate reporting” (item 734), and “new earned premium” (item 736) is an input to the “loss analysis of change” model (item 738). “New earned premium” (item 736) in turn may be derived by applying an earning pattern to “new written premium” (item 722).

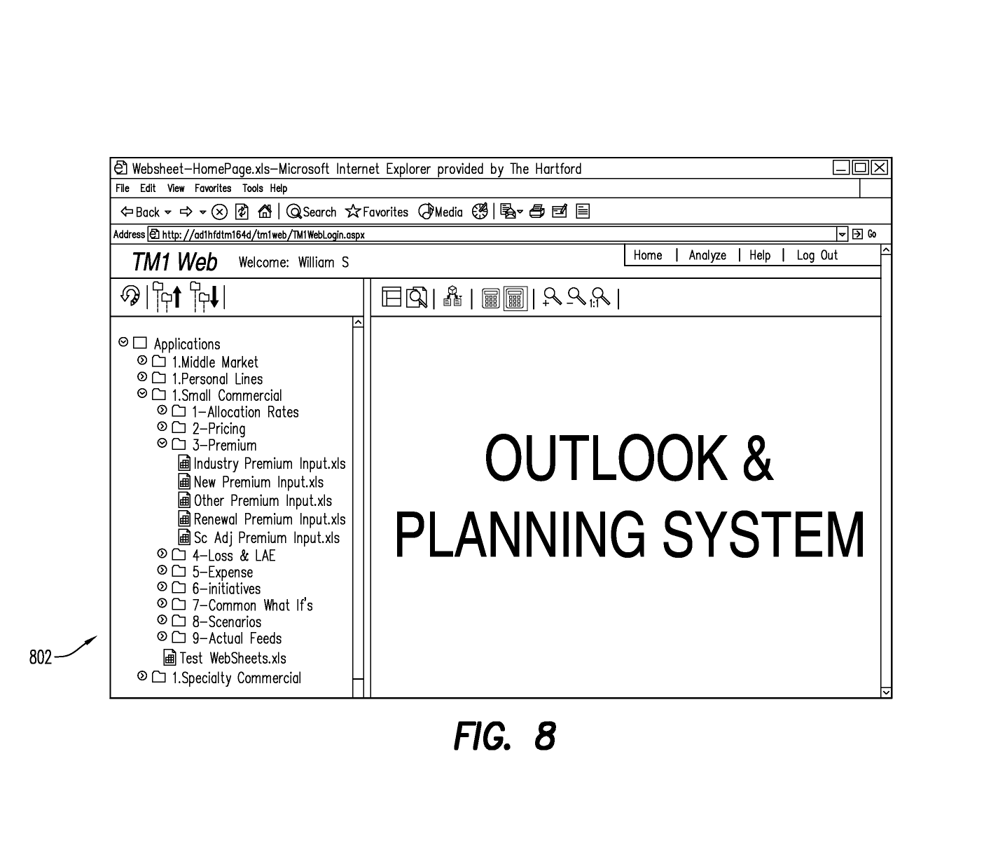

The planning server computer 312 may host the above-mentioned data model as an OLAP (online analytical processing) model, which is accessible to users via the user computers 314 for purposes of entering inputs to the planning model or to download results of planning/forecasting processing performed by the planning server computer 312. FIG. 8 is an example “welcome” screen display that may be downloaded to user computers 314 from the planning server computer 312 when a user first accesses the outlook and planning system. Seen at 802 in FIG. 8 is a menu of options that allow the user to begin navigating through the outlook and planning system. Options available through the menu 802 include various business segments, and components of both revenue and expense/loss sides of the planning and financial reporting processes.

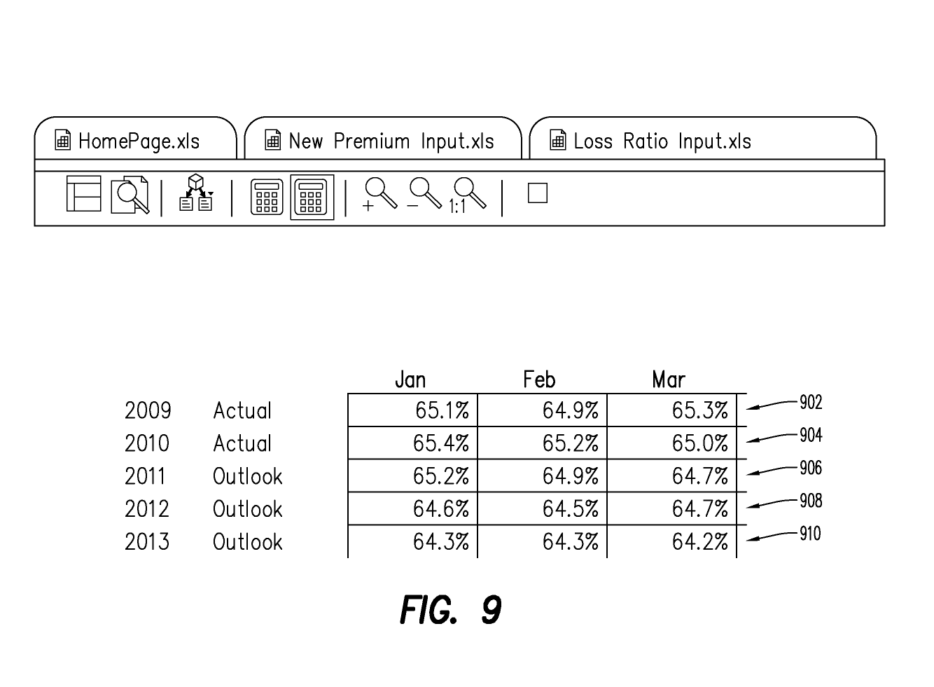

FIG. 9 is a partial view of another screen display that may be presented (downloaded) to users of the outlook and planning system. This screen display may be used by an insurance company employee to enter data to be used as an input to the forecasting process. In this particular example, the cells in the first two rows 902 and 904 contain actual data from prior time periods, and therefore cannot be overwritten. The cells in the other rows 906, 908 and 910 are available for the employee to enter predictions/projections for future time periods. In this particular simplified example, the cells are available to receive projections as to loss ratios that will be experienced in future months. In other screen displays cells may be similarly provided for other inputs required by the forecasting data model, including for example inputs mentioned in connection with FIG. 7, and other inputs required for other portions of the data model.

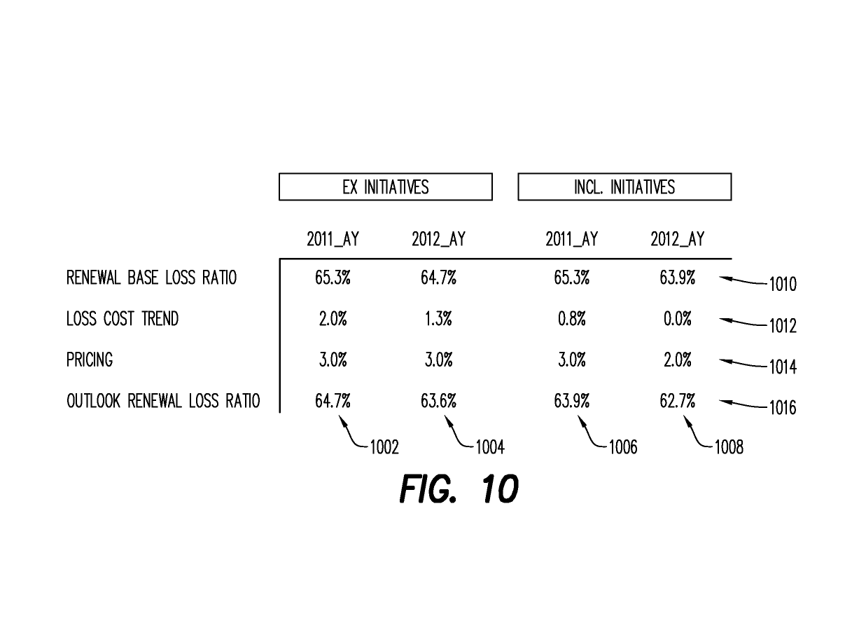

FIG. 10 is a simplified example of a table that may be included in a report/screen display accessed by a user of the outlook and planning system to view results of the forecasting process. In this simplified example table, columns 1002 and 1004 represent forecasts generated for future years based on the assumption that certain proposed management initiatives are not undertaken. Specifically, columns 1002 and 1004 show expected results for future years 2011 and 2012, respectively. Columns 1006 and 1008 respectively represent forecasts for 2011 and 2012 based on the assumption that the initiatives in fact are undertaken. Thus the table shown in FIG. 10 presents expected results of initiatives side-by-side for comparison with results that are forecast to occur in the absence of the initiatives.

In this simplified example, the forecast relates to loss ratio, which is a constituent component of the data model relating to loss expenses relative to claims under policies expected to be in force. Specifically, the first row 1010 indicates the base (prior year) loss ratio, and the next row 1012 indicates the expected trend (year over year change) in loss ratio due to changes in loss costs. The third row 114 indicates the expected trend in loss ratio due to changes in pricing, and the bottom row 1016 indicates the expected outlook loss ratio for the forecast year in question.

This table is a simplified example of forecast information that may be generated by an “analysis of change” model provided in accordance with aspects of the present invention. In a more detailed embodiment of the invention, tables reflecting forecast results may include a considerable number of additional rows. For example, such additional rows may reflect inputs (either manual or from other portions of the model) relating to trends in loss ratios for renewal policies, trends in loss ratios for new business, “penalties” for new business loss ratios (reflecting a greater tendency for losses for new business relative to renewals), effects of planned initiatives relating to the “mix” of insureds, effects of planned initiatives relating to loss adjustment expense (allocated and/or unallocated), etc. Thus in a detailed embodiment, a table having upwards of 20 rows, including various subtotals, may be provided.

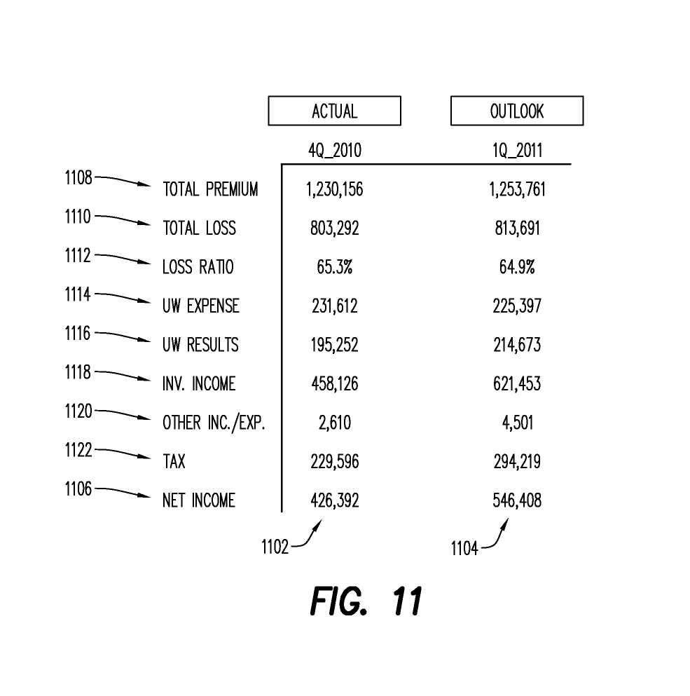

FIG. 11 is another simplified example table that may be included in a report/screen display accessed by a user of the outlook and planning system to view results of the forecasting process. In this example, column 1102 represents actual financial results for the latest quarter (assumed to be the fourth quarter of 2010) and column 1104 represents forecast results for the next calendar quarter (in this example, the first quarter of 2011).

(For ease of presentation, the last three digits—e.g., “000”—have been omitted from the figures.)

The “bottom line”, i.e., the net income figure, is shown in the last row 1106 in the table. Other rows show the “top line” (total premium revenue—row 1108) and total loss expense (row 1110). The loss ratio (total loss divided by total premium) is shown at row 1112. Underwriting expense figures are found in row 1114, and underwriting results figures appear at row 1116. Investment income figures are provided in row 1118. Row 1120 holds figures relating to other income and expenses, and tax figures are shown in row 1122.

It will be appreciated that the table shown in FIG. 11 may summarize information provided by other tables, which are not shown, and/or appears in a form that is simplified in a number of ways. For example, in an alternative embodiment of the table, there may be additional columns for earlier and/or later calendar quarters, and/or actual and forecast calendar year results. In addition, or alternatively, the table may break out the financial results among business segments.

Still further, the table may have a number of rows in addition to those shown in FIG. 11. For example, there may be rows which break down the total premiums among renewal premiums, new business premiums, and other premiums. Other rows may indicate the effects of reinsurance treaty transactions. Still other rows may break down the loss figures among direct losses, allocated loss adjustment expense and unallocated loss adjustment expense. In addition, other expenses may be reflected by separate line items (rows) such as commissions, other underwriting expense, TL&F and prepaid acquisition.

In some embodiments a table like FIG. 11 may be generated for each line of business and/or market segment, in addition to an overall income statement.

In some embodiments, numerous other types of tables/reports may be provided with respect to forecasts generated by the planning server computer 312. For example, in one embodiment, a particular cost/expense or revenue component, as forecast, may be reported in the form of a table, with one line item for expected trends absent adoption of any initiative and then separate line items for each proposed or planned initiative, including the expected effect of the respective initiative on the cost/expense/revenue component in percentage terms.

With respect to loss costs, another type of table may contain separate line items to reflect percentage changes in frequency of claims and in severity of claims.

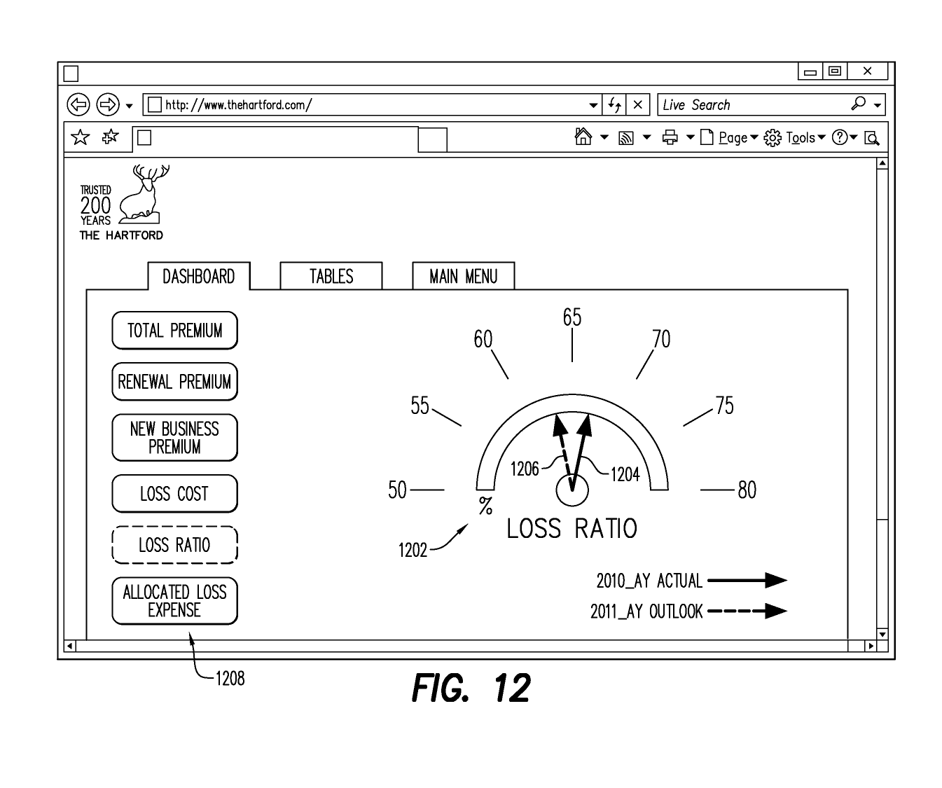

In addition to or as an alternative for the tables such as shown in FIGS. 10 and 11, forecast and/or actual financial results may be presented to users in other ways, including for example in “dashboard” displays. FIG. 12 is an example screen display in a dashboard format which shows both actual and forecast financial results. This screen display may be generated by the planning server computer 312 and downloaded for display on the user computers 314 to service requests from the user computers 314.

It will be noted that the screen display of FIG. 12 includes a dial gauge display element 1202. In this example screen display, the actual and forecast results shown relate to loss ratio. In particular, gauge arrow 1204 indicates the actual loss ratio for the latest calendar year (assumed to be 2010), while gauge arrow 1206 indicates the forecast loss ratio for the next calendar year. A column of navigation buttons 1208 at the left side of the screen display allows the user to navigate to similar screen displays related to other metrics, such as total premium, renewal premium, new business premium, loss cost or allocated loss expense.

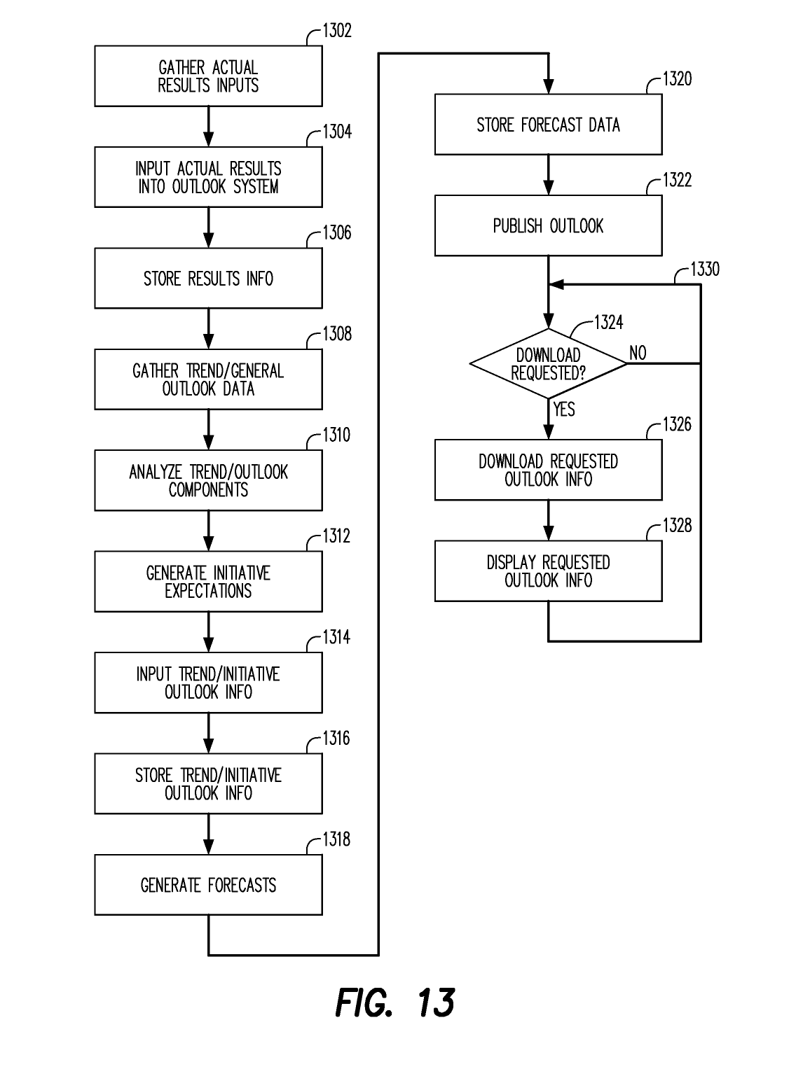

FIG. 13 is a flow chart that illustrates a process that may be performed in the insurance company computer system shown in FIGS. 2 and 3.

At 1302 in FIG. 13, actual financial results are gathered for one or more time periods. This may occur, for example, in the financial reporting server 310 shown in FIG. 3, and may be done in accordance with conventional practices. At 1304, the financial result information may be fed from the financial reporting server 310 to the planning server computer 312. At 1306, the planning server computer 312 stores the financial result information it receives from the financial reporting server 310.

At 1308, one or more employees of the insurance company may gather information relating to general economic trends, the business outlook for the insurance industry and/or trends that appear to be occurring within the activities of the insurance company itself (e.g., market share trends in various lines of business or market segments, trends in claim frequency and/or severity). At least some of the information obtained at 1308 may come from outside public or private sources, such as government or private economic forecasts, insurance industry research bodies, etc.

At 1310, the insurance company employee(s) analyze the information obtained at 1310 to produce expected trends for a number of revenue and/or cost components. For example, the resulting trend inputs may be expressed in terms of an expected percentage change on a period-over-period basis (e.g., an expected year-to-year percentage change). The analysis and/or gathering of the information from which trend inputs are derived may be done manually and/or at least in part automatically by software agents running in the planning server computer 312 and/or in one or more of the user computers 314.

At 1312, the same or other insurance company employees may consider and review various management or business initiatives that have been planned or proposed for implementation by the insurance company. This may also include conceiving of, designing and/or planning such initiatives. In some embodiments, conception of at least some of the business initiatives may be prompted by the results of steps 1310 and 1312, where expected future trends are identified. Other initiatives may be developed in response to corporate goals, such as goals for net income, revenue and/or reduction of expenses and costs. Based on planning and/or analysis of the proposed or planned initiatives, the employees may estimate the probable effect of each initiative on one or more revenue or expense/cost component. This estimate may, for example, be expressed as an expected change in percentage terms in the revenue/expense/cost component.

At 1314, the employees enter the trend and expected initiative result information into the planning server computer 312. This may occur for example via interaction between the planning server computer 312 and user computers 314 operated by the employees. An example data input display screen is depicted in FIG. 9 and was discussed above; other suitable data input display screens may also be provided by the planning server computer 312 via the user computers 1314, including input screens with cells for entering trend or initiative effect data for particular future periods, for revenue/expense/cost components and/or for lines of business or market segments.

At 1316, the planning server computer 312 stores the information entered at 1314.

At 1318, the planning server computer 312 generates one or more forecasts based on the information received and stored at 1304, 1306, 1314 and 1316. This may entail OLAP operations using a model made up of data cubes that reflect the insurance company's accounting and planning practices. As guided by those practices and in accordance with teachings of the present invention, a suitable set of data cubes may have been defined and a suitable set of rules may have been written to define the data flows among the cubes. Examples of suitable data flows have been described above.

At 1320, the planning server computer 312 stores the forecast data produced at 1318. At 1322, the planning server computer 312 makes the forecast data available to users via downloads to their computers 314. Specifically, at decision block 1324 the planning server computer 312 may determine whether a download of some of the forecast data is requested by one of the user computers 314, and if so, the requested outlook data may be downloaded, as indicated at 1326. The user computer 314 then displays the outlook data to the user, as indicated at 1328. Between download requests, the process of FIG. 13 may idle at 1324, as indicated by process branch 1330. Example outlook data displays have been depicted in FIGS. 10 and 11 and discussed above. Other example displays have been described herein. Many other displays of outlook data are possible in accordance with teachings herein, as will be appreciated by those who are skilled in the art.

A centralized online outlook and planning system as described herein may greatly increase efficiency and reduce required time and effort as compared to spreadsheet-based or ad hoc planning software solutions. Information may be easily shared across departments, both as to inputs for the planning function and in disseminating resulting forecasts and plans. The system described herein also facilitates ongoing and continuous planning and tracking of initiatives and trends, as compared to prior art episodic planning processes. Manual updating may be reduced or eliminated. Data spreading tools may allow data inputs to be automatically spread across table structures.

Further, the system described herein may facilitate transparency relative to planning assumptions and formulas employed in the planning process. Multiple “what-if” analyses are also readily supported.

The system described herein also promotes accuracy in reporting and forecasting by housing rules and calculations within the system and eliminating any need to link together multiple spreadsheet-based models. Data updates may be automated and reconciled (through interaction with the financial reporting system).

A system as disclosed herein may also promote system resiliency, in that a single backup process may provide complete disaster recovery readiness for the outlook and planning system, instead of multiple recovery facilities that may be needed for decentralized or piecemeal planning approaches.

Particularly in the case of a multi-line insurance company, the planning system according to the present invention may facilitate aggregation of outlooks with the same metrics across multiple lines of business. Sensitivity and what-if analyses may be rapidly performed. The system described herein also facilitates strategic planning without labor-intensive translations of data from one model to another, because custom-made strategic planning models are no longer required.

Processes portrayed herein as being performed by one computer may in practice be divided among two or more computers. Processes portrayed herein as being performed by two or more computers may in practice be performed by a single computer. For example, the financial reporting server computer 310 and the planning server computer 312 may be integrated together as a single computer.

The process descriptions and flow charts contained herein should not be considered to imply a fixed order for performing process steps. Rather, process steps may be performed in any order that is practicable.

As used herein and in the appended claims, the term “computer” refers to a single computer or to two or more computers in communication with each other and/or operated by a single organization or by two or more organizations that are partly or entirely under common ownership and/or control.

As used herein and in the appended claims, the term “processor” refers to one processor or two or more processors that are in communication with each other.

As used herein and in the appended claims, the term “memory” refers to one, two or more memory and/or data storage devices.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computerized financial outlook and planning system, comprising:
a financial results input module for inputting financial results data, the financial results data indicative of operating results of an insurance company and including data that represents (a) revenues received as insurance premium payments, and (b) losses suffered as a result of claims made under policies issued by the insurance company;
a financial results storage module, coupled to the financial results input module, for receiving and storing the financial results data;
a trend information input module for inputting information indicative of expected trends in financial results, said information indicative of expected trends in financial results including information indicative of expected trends in renewals of insurance policies and expected trends in issuance of new insurance policies;
an initiative information input module for inputting information indicative of expected results of at least one initiative intended to change at least one of said expected trends;
a forecasting module, coupled to the financial results storage module, the trend information input module and the initiative information input module, for receiving the financial results data, the information indicative of expected trends in financial results and the information indicative of expected results of the at least one initiative, the forecasting module including a processor programmed to process the financial results data, the information indicative of expected trends in financial results and the information indicative of expected results of the at least one initiative and to generate forecast data, the forecast data including first forecast data indicative of forecast financial results without considering said at least one initiative and second forecast data that indicates forecast financial results that reflect expected results of said at least one initiative;
a forecast data storage module, coupled to the forecasting module, for storing the first and second forecast data; and
a display module coupled to the forecast data storage module for displaying the first and second forecast data.

2. The computerized financial outlook and planning system of claim 1, wherein said at least one initiative includes at least one of (a) introduction of a new insurance product, (b) a change in pricing of insurance policies, and (c) a change in claim handling procedures.

3. The computerized financial outlook and planning system of claim 1, further comprising:
a tracking module, coupled to the financial results storage module and the forecast data storage module, for receiving updated financial results data and comparing the updated financial results data with the forecast data;
wherein:
the tracking module generates variance data that indicates differences between the updated financial results data and the forecast data; and
the financial results storage module is coupled to the tracking module and stores the variance data.

4. The computerized financial outlook and planning system of claim 3, wherein the display module displays the variance data with the updated financial results data and the forecast data.

5. A computerized financial outlook and planning system, comprising:
a financial results input module for inputting financial results data;
a financial results storage module, coupled to the financial results input module, for receiving and storing the financial results data;
a trend information input module for inputting information indicative of expected trends in financial results;
an initiative information input module for inputting information indicative of expected results of at least one initiative intended to change at least one of said expected trends;
a forecasting module, coupled to the financial results storage module, the trend information input module and the initiative information input module, for receiving the financial results data, the information indicative of expected trends in financial results and the information indicative of expected results of the at least one initiative, the forecasting module including a processor programmed to process the financial results data, the information indicative of expected trends in financial results and the information indicative of expected results of the at least one initiative and to generate forecast data, the forecast data including first forecast data indicative of forecast financial results without considering said at least one initiative and second forecast data that indicates forecast financial results that reflect expected results of said at least one initiative;
a forecast data storage module, coupled to the forecasting module, for storing the first and second forecast data; and
a display module coupled to the forecast data storage module for displaying the first and second forecast data.

6. The computerized financial outlook and planning system of claim 5, wherein the display module displays the first and second forecast data simultaneously in a screen display page.

7. The computerized financial outlook and planning system of claim 5, wherein the display module displays the first and second forecast data together in a dashboard display format.

8. The computerized financial outlook and planning system of claim 5, further comprising:
a tracking module, coupled to the financial results storage module and the forecast data storage module, for receiving updated financial results data and comparing the updated financial results data with the forecast data;
wherein:
the tracking module generates variance data that indicates differences between the updated financial results data and the forecast data; and
the financial results storage module is coupled to the tracking module and stores the variance data.

9. The computerized financial outlook and planning system of claim 8, wherein the display module displays the variance data with the updated financial results data and the forecast data.

10. The computerized financial outlook and planning system of claim 5, wherein said financial results and said forecast data relate to insurance premium revenues received by an insurance company and to losses resulting from claims brought under insurance policies written by the insurance company.

11. The computerized financial outlook and planning system of claim 10, wherein said financial results data and said forecast data relate to revenues obtained from renewals of insurance policies and revenues obtained from issuing new insurance policies.

12. The computerized financial outlook and planning system of claim 10, wherein said financial results data and said forecast data relate to direct losses due to claims and indirect expenses of handling claims.

13. A method of operating a computer system, the method comprising:
receiving and storing financial results data in a storage module;
receiving information indicative of expected trends in financial results;
receiving information indicative of expected results of at least one initiative intended to change said expected trends;
processing the financial results data, the information indicative of expected trends in financial results and the information indicative of expected results of the at least one initiative with a processor coupled to the storage module, the processor generating first and second forecast data from the financial results data, the information indicative of expected trends in financial results and the information indicative of expected results of the at least one initiative, the first forecast data indicative of forecast financial results without considering said at least one initiative and the second forecast data indicative of forecast financial results that reflect said expected results of said at least one initiative;
storing the first and second forecast data; and
displaying the first and second forecast data on a display module.

14. The method of claim 13, wherein the display module displays the first and second forecast data simultaneously in a screen display page.

15. The method of claim 13, wherein the display module displays the first and second forecast data together in a dashboard display format.

16. The method of claim 13, further comprising:
receiving updated financial results data;
comparing the updated financial results data with the forecast data;
generating variance data that indicates differences between the updated financial results data and the forecast data; and
storing the variance data.

17. The method of claim 16, further comprising:
displaying the variance data with the updated financial results data and the forecast data on the display module.

18. The method of claim 13, wherein said financial results and said forecast data relate to insurance premium revenues received by an insurance company and to losses resulting from claims brought under insurance policies written by the insurance company.

19. A computerized financial outlook and planning system, comprising:
a financial results input module for inputting financial results data;
a financial results storage module, coupled to the financial results input module, for receiving and storing financial results data;
a trend information input module for inputting information indicative of expected trends in financial results;
a forecasting module, coupled to the financial results storage module and the trend information input module, for receiving the financial results data and the information indicative of expected trends in financial results, the forecasting module including a processor programmed to process the financial results data and the information indicative of expected trends in financial results and to generate forecast data, the forecast data indicative of expected future financial results;
a forecast data storage module, coupled to the forecasting module, for storing the forecast data; and
a display module coupled to the forecast data storage module for displaying the forecast data in a dashboard display format.

20. The computerized financial outlook and planning system of claim 19, wherein the dashboard display format includes at least one dial gauge display element.

21. The computerized financial outlook and planning system of claim 20, wherein the dial gauge display element indicates both a current actual financial result and a corresponding future forecast financial result.

22. The computerized financial outlook and planning system of claim 19, wherein said financial results and said forecast data relate to insurance premium revenues received by an insurance company and to losses resulting from claims brought under insurance policies written by the insurance company.

23. A method of operating a computer system, the method comprising:
receiving and storing financial results data in a storage module;
receiving information indicative of expected trends in financial results;
receiving the financial results data and the information indicative of expected trends in financial results and processing the financial results data and the information indicative of expected trends in financial results with a processor to generate forecast data, the forecast data indicative of expected future financial results;
storing the forecast data; and
displaying the forecast data in a dashboard display format on a display module.

24. The method of claim 23, wherein the dashboard display format includes at least one dial gauge display element.

25. The method of claim 24, wherein the dial gauge display element indicates both a current actual financial result and a corresponding future forecast financial result.

26. The method of claim 23, wherein said financial results and said forecast data relate to insurance premium revenues received by an insurance company and to losses resulting from claims brought under insurance policies written by the insurance company.
